(19) United States
(12) Patent Application Publication
(10) Pub. No.: US 2026/0299080 A1
(43) Pub. Date: Oct. 1, 2026

(54) SELF-INTERFERENCE CANCELLATION FOR FREQUENCY-MODULATED CONTINUOUS-WAVE RADAR

(71) Applicant: QUALCOMM Incorporated, San Diego, CA (US)

(72) Inventors: Roberto RIMINI, San Diego, CA (US); Ojas CHOKSI, San Diego, CA (US); Wu-Hsin CHEN, San Diego, CA (US)

(21) Appl. No.: 19/091,295

(22) Filed: Mar. 26, 2025

(51) Int. Cl. G01S 7/02; G01S 13/32

(52) U.S. Cl. CPC G01S 7/0232; G01S 13/32

(57) ABSTRACT

In some aspects, a wireless device may comprise a transmitter configured to transmit a first frequency-modulated continuous-wave (FMCW) signal and a receiver configured to receive a second FMCW signal associated with self-interference caused by a mutual coupling from the transmitter to the receiver. In some aspects, the wireless device may comprise an adaptive cancellation component configured to modulate a sample of the first FMCW signal based on a frequency offset associated with the mutual coupling from the transmitter to the receiver. The adaptive cancellation component may be configured to generate an estimate of the second FMCW signal based on the modulated sample of the first FMCW signal. The adaptive cancellation component may be configured to cancel the self-interference caused by the mutual coupling from the transmitter to the receiver based on the estimate of the second FMCW signal.

### FIELD OF THE DISCLOSURE

Aspects of the present disclosure generally relate to wireless transceivers, and to cancelling self-interference in a wireless transceiver with radar sensing capabilities.

### BACKGROUND

Frequency-modulated continuous-wave (FMCW) radar is a sensing technology often used to measure distances, measure velocities, and/or detect objects in an environment. For example, an aircraft may use FMCW radar as an altimeter to measure the height of the aircraft during takeoff or landing, an inventory management system may use FMCW radar to measure levels in a process plant, and/or a user equipment (UE) may use FMCW radar to detect the presence of and/or measure the distance to human tissue to ensure compliance with maximum permissible exposure (MPE) requirements. In a device with FMCW sensing capabilities, the device may transmit a frequency-modulated signal, for example a chirp, with a frequency that increases or decreases over time and a defined frequency bandwidth. If an object in a surrounding environment is in a path of the transmitted signal, the object will totally or partially reflect the radar waves back to the wireless device, and the received signal may be delayed relative to the transmitted signal, may have a different frequency than the transmitted signal, and/or may have a different amplitude or phase than the transmitted signal. Accordingly, the device may detect the presence of the object and/or may determine an exact distance to the object based on a frequency shift or frequency offset between the transmitted signal and the received signal. Furthermore, a frequency difference between the transmitted signal and the received signal may indicate the range to the object, and a change in the distance to the object over multiple measurements may indicate the velocity of the object and/or the device sensing the object.

### SUMMARY

In some implementations, a wireless device includes a transmitter configured to transmit a first frequency-modulated continuous-wave (FMCW) signal; a receiver configured to receive a second FMCW signal associated with self-interference caused by a mutual coupling from the transmitter to the receiver; an adaptive cancellation component configured to: modulate a sample of the first FMCW signal based on a frequency offset associated with the mutual coupling from the transmitter to the receiver; generate an estimate of the second FMCW signal based on the modulated sample of the first FMCW signal; and cancel the self-interference caused by the mutual coupling from the transmitter to the receiver based on the estimate of the second FMCW signal.

In some implementations, a method for mutual coupling cancellation includes sampling, by a circuit, a transmit chirp; modulating, by the circuit, the transmit chirp with a continuous-wave (CW) tone having a frequency based on a mutual coupling delay associated with the transmit chirp; estimating, by the circuit, a receive chirp based on the modulated transmit chirp and one or more estimated parameters associated with a mutual coupling channel; and cancelling, by the circuit, a mutual coupling signal from the receive chirp based on the estimated receive chirp.

In some implementations, a method for adaptive delay compensation includes obtaining, by a circuit, a beat signal by multiplying a transmitted reference chirp with an interfering signal caused by mutual coupling from a transmitter to a receiver; applying, by the circuit, a discrete Fourier transform (DFT) to the beat signal to generate a spectrum representing the beat signal in a frequency domain; generating, by the circuit, a CW tone having a frequency associated with a maximum peak in the spectrum representing the beat signal; and providing, by the circuit, the CW tone to a cancellation filter configured to cancel a mutual coupling signal from a receive chirp based on a sampled transmit chirp, the CW tone, and one or more parameters associated with the mutual coupling.

Aspects generally include an apparatus, a method, a system, a wireless communication device, a transceiver, a receiver, a filter, and/or a circuit, as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment with an electronic device that includes a wireless interface, in accordance with the present disclosure.

FIG. 2 is a diagram illustrating an example environment in which self-interference cancellation may be performed for frequency-modulated continuous-wave (FMCW) radar, in accordance with the present disclosure.

FIG. 3 is a diagram illustrating an example associated with analog self-interference cancellation for FMCW radar, in accordance with the present disclosure.

FIG. 4 is a diagram illustrating an example associated with an uncompensated delay between a received FMCW signal and an estimated mutual coupling signal, in accordance with the present disclosure.

FIG. 5 is a diagram illustrating an example associated with a spectral shift caused by a delay between FMCW signals, in accordance with the present disclosure.

FIG. 6 is a diagram illustrating an example associated with analog self-interference cancellation for FMCW radar with digital feedback for adaptive delay compensation, in accordance with the present disclosure.

FIGS. 7-8 are flowcharts illustrating example methods associated with analog self-interference cancellation for FMCW radar with digital feedback for adaptive delay compensation, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

In a wireless device with frequency-modulated continuous-wave (FMCW) sensing capabilities, the wireless device may simultaneously transmit and receive FMCW signals at the same carrier frequency to detect objects in an environment and/or obtain distance-related measurements associated with objects in the environment. For example, the wireless device may transmit a first FMCW signal via one or more transmit antennas, and may concurrently receive a second FMCW signal via one or more receive antennas. However, due to over-the-air and/or on-chip mutual coupling, the second (received) FMCW signal may include a mutual coupling signal (or mutual coupling component) in addition to a target signal that corresponds to a reflected version of the first (transmitted) FMCW signal. For example, mutual coupling results from the electromagnetic interaction between nearby antennas and/or transducers, which may occur when a transmitted signal is received at a nearby received antenna and/or when a transmitted signal leaks through an antenna duplexer or other component in a wireless transmitter into a receive path in a wireless receiver. In wireless devices with FMCW sensing capabilities, the mutual coupling signal typically has a significantly higher power level than the target signal to be sensed (e.g., because the target signal typically travels a longer path than the mutual coupling signal and an object that reflects the transmitted FMCW signal typically absorbs a portion of the energy). In some cases, a low noise amplifier in an FMCW receive path may have a very high linearity to avoid compression and/or saturation caused by transmit self-interference (TxSI) or mutual coupling. However, the linearity requirement to overcome the high power level associated with the TxSI or mutual coupling is very stringent, and challenging to satisfy in practice.

Accordingly, in some cases, a wireless device with FMCW sensing capabilities may include or may be coupled to a filter configured to cancel the TxSI or mutual coupling from the received FMCW signal, where effectively cancelling the TxSI or mutual coupling may reduce an effect associated with phase noise reciprocal mixing that can significantly contribute to desensing the target signal contained within the received FMCW signal. For example, in one approach, the TxSI or mutual coupling may be cancelled in an analog domain using an adaptive complex radio frequency (RF) least mean squares (LMS) algorithm in which over-the-air mutual coupling and on-chip mutual coupling are modeled together as a time-varying one-path complex channel (e.g., because the over-the-air and on-chip components making up a mutual coupling signal are typically associated with a very small delay spread that cannot be resolved by a radar bandwidth). For example, in a wireless device with FMCW sensing capabilities, a received FMCW signal is identical to the transmitted FMCW signal, except that the received FMCW signal may have a different amplitude and/or phase than the transmitted FMCW signal that is at least partially caused by the mutual coupling. Accordingly, the TxSI or mutual coupling filter may implement the adaptive complex RF LMS algorithm to estimate and track the amplitude and the phase associated with the mutual coupling channel, such that the mutual coupling signal can be estimated according to a sample of the transmitted FMCW signal. In this way, the estimated mutual coupling signal may be cancelled from the received FMCW signal, which may enable the target (reflected) signal to be appropriately sensed.

However, even in cases where the mutual coupling channel is perfectly estimated (e.g., one or more weights representing the amplitude and the phase associated with the mutual coupling channel are perfectly estimated), there is also an uncompensated relative delay between the received mutual coupling signal and the estimated mutual coupling signal at a cancellation node (e.g., a point in the receive path where the estimated mutual coupling signal is cancelled from the received mutual coupling signal). As a result, the uncompensated relative delay between the received mutual coupling signal and the estimated mutual coupling signal may degrade a cancellation depth (e.g., the TxSI or mutual coupling power cancelled from the received FMCW signal significantly decreases as the uncompensated delay increases, even at a sub-nanosecond scale). Furthermore, the cancellation depth may be reduced at higher frequencies and lower frequencies within the radar bandwidth (e.g., frequencies that are farther from a center frequency) due to a larger uncompensated relative delay.

Some aspects described herein relate to an adaptive cancellation filter (or component) that may cancel self-interference (or mutual coupling) from a received FMCW signal according to an estimated delay between a mutual coupling signal included in the received FMCW signal and an estimate of the mutual coupling signal at a cancellation node. For example, as described herein, an FMCW signal is associated with a frequency that changes over time (e.g., increases or decreases linearly over time). Accordingly, a delay applied to an FMCW signal (for example, a chirp) results in a spectral shift in a frequency domain that is proportional to the delay. For example, in a scenario where a first FMCW signal has a particular frequency at a first time and a second FMCW signal has the same frequency at a second time, a frequency offset or difference between the first FMCW signal and the second FMCW signal is proportional to the delay between the first FMCW signal and the second FMCW signal.

Accordingly, some aspects described herein relate to an adaptive cancellation filter that may estimate the delay between a mutual coupling signal and an estimate of the mutual coupling signal, such that a sample of a transmitted signal may be modulated by a continuous-wave (CW) tone with a frequency that is based on the estimated delay. For example, one or more components in a wireless device may apply a discrete Fourier transform (DFT) to a beat signal that combines a mutual coupling signal and a target signal, where the DFT may map the beat signal to a spectrum in a frequency domain. Accordingly, because the mutual coupling signal typically has a much higher power than the target signal, a peak in the post-DFT (pre-cancellation) spectrum may correspond to a frequency offset related to the delay between the received mutual coupling signal and the estimated mutual coupling signal. In this way, the frequency offset may be used to generate the CW tone used to modulate the transmit chirp that is sampled to estimate the mutual coupling signal, and the adaptive complex RF LMS algorithm may then be used to estimate the mutual coupling signal.

While aspects and/or use cases are described herein with reference to one or more illustrative examples, additional aspects and/or and use cases may apply in different arrangements and scenarios. Aspects described herein may be implemented across various platform types, devices, systems, shapes, sizes, and/or packaging arrangements. For example, some aspects and/or use cases described herein may be implemented via integrated chip embodiments and/or other devices (e.g., end user devices, vehicles, communication devices, computing devices, industrial equipment, medical devices, artificial intelligence (AI)-enabled devices, aerial devices, or the like). Some aspects described herein may be implemented in various configurations, such as chip-level or modular components, non-modular, non-chip-level implementations, and/or aggregate, distributed, or original equipment manufacturer (OEM) devices or systems incorporating one or more aspects described herein. In some cases, a device incorporating one or more aspects and/or features described herein may include additional components and/or features that may be used to implement the one or more aspects and/or features described herein. For example, transmitting and receiving wireless signals, such as FMCW signals, may be implemented using various analog and/or digital components (e.g., hardware components including antennas, radio frequency (RF) chains, power amplifiers, modulators, buffers, processors, interleavers, and/or adders/summers, among other examples).

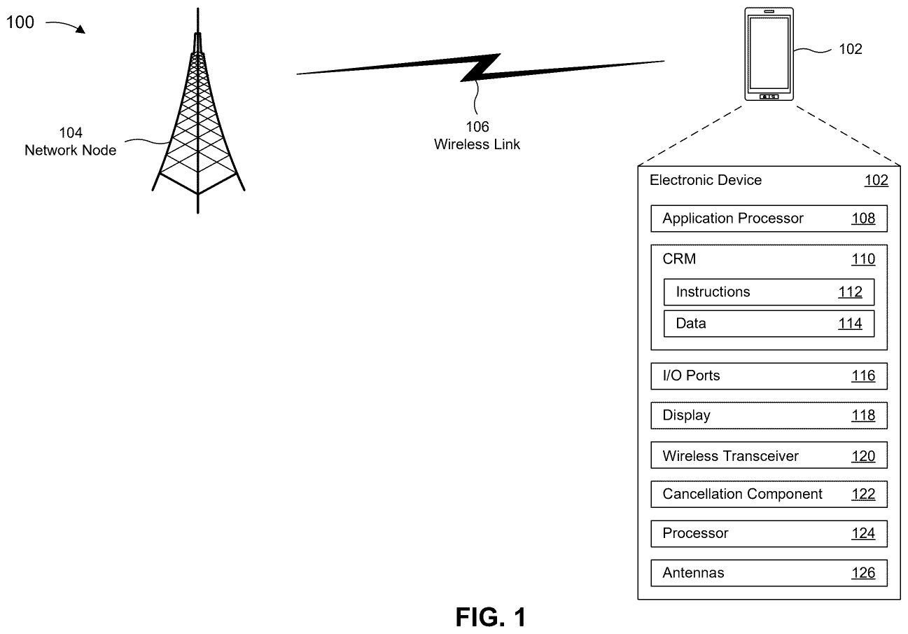

FIG. 1 is a diagram illustrating an example environment 100 with an electronic device 102 that includes a wireless transceiver 120, in accordance with the present disclosure. In some aspects, as described in further detail elsewhere herein, the wireless transceiver 120 may include one or more components in a transmit path that may transmit a first FMCW signal, or Tx chirp, and one or more components in a receive path that may receive a second FMCW signal, or Rx chirp. As described herein, the received FMCW signal, or Rx chirp, may include a target signal (to be sensed) corresponding to a reflected version of the transmitted FMCW signal and a mutual coupling (interfering) signal associated with over-the-air (OTA) and/or on-chip leakage of the transmitted FMCW signal. Accordingly, in some aspects, the electronic device 102 may include a cancellation component 122 configured to estimate the mutual coupling signal and to cancel the mutual coupling signal from the received FMCW signal such that the target signal can be sensed to detect an object in proximity to the electronic device 102, measure a distance to the object, and/or a measure a velocity of the object or the electronic device 102, among other examples.

In the example environment 100, the electronic device 102 may communicate with a network node 104 through a wireless link 106. For example, the network node 104 may include one or more devices, components, or systems that enable communication between the electronic device 102 and one or more devices, components, or systems in the environment 100. The network node 104 may be, may include, or may also be referred to as a base station, a cellular network tower, a New Radio (NR) network node, a 5G network node, a 6G network node, a Node B, an eNB, a gNB, an access point (AP), a transmission reception point (TRP), a mobility element, a core network entity, a network element, a network equipment, a radio unit (RU), a distributed unit (DU), a central unit (CU), and/or another suitable device.

The electronic device 102 may be any suitable computing device or other electronic device. For example, the electronic device 102 may be a smartphone, a cellular base station, a broadband router, an AP, a modem, a cellular or mobile phone, a user equipment (UE), a gaming device, a navigation device, a media device, a laptop computer, a desktop computer, a tablet computer, a server computer, a network-attached storage (NAS) device, a smart appliance, a vehicle-based communication system, an Internet of Things (IoT) device, a sensor or security device, an asset tracker, a fitness management device, a wearable device such as smart glasses or a smartwatch, a wireless power device (transmitter or receiver), a medical device, or the like.

The network node 104 may communicate with the electronic device 102 via the wireless link 106, which may be implemented as any suitable wireless link that carries a wireless communication signal. For example, the wireless link 106 may be implemented in a wireless network, which may include a cellular network, a public land mobile network (PLMN), a wireless local area network (WLAN), a wide area network (WAN), a metropolitan area network (MAN), a telephone network (e.g., the Public Switched Telephone Network (PSTN)), a private network, an ad hoc network, an intranet, a wireless personal area network (WPAN), and/or a combination of these or other networks. Although depicted as a base station tower in a cellular radio access network, the network node 104 may represent or be implemented as another device, such as a satellite, a terrestrial broadcast tower, an AP, a peer-to-peer device, a mesh network node, another electronic device as described above generally, or the like. Furthermore, although the electronic device 102 is depicted as communicating with the network node 104 via the wireless link 106, the electronic device 102 may communicate with the network node 104 or another device via a wired and/or wireless connection.

The wireless link 106 may include a downlink for communicating data or control information from the network node 104 to the electronic device 102, an uplink for communicating data or control information from the electronic device 102 to the network node 104, a sidelink for communicating data or control information from the electronic device 102 to the network node 104 or vice versa, or any suitable combination thereof. The wireless link 106 may be implemented using any suitable communication protocol or standard, such as a 3rd Generation Partnership Project Long-Term Evolution (3GPP) standard, such as a 4th Generation (4G), a 5th Generation (5G), a 6th Generation (6G), or another wireless communication standard, an Institute of Electrical and Electronics Engineers (IEEE) 802.11 or IEEE 802.16 standard, a Bluetooth standard, or the like. In some aspects, the wireless link 106 may wirelessly provide power instead of or in addition to communication signaling, and the electronic device 102 or the network node 104 may be a power source or a power sink.

As shown in FIG. 1, the electronic device 102 may include at least one application processor 108 and at least one computer-readable storage medium 110. The application processor 108 may include any suitable processor, such as a central processing unit (CPU) or a multicore or graphics processor, configured to execute processor-executable instructions (e.g., code) stored by the computer-readable storage medium 110. The computer-readable storage medium 110 may include any suitable data storage media, such as volatile memory (e.g., random-access memory (RAM)), non-volatile memory, optical media, magnetic media (e.g., disk or tape), or the like. The computer-readable storage medium 110 may be implemented to store instructions 112, data 114, or other suitable information, and therefore the computer-readable storage medium 110 does not include transitory propagating signals or carrier waves.

As shown in FIG. 1, the electronic device 102 may include one or more input/output (I/O) ports 116 and at least one display 118. The I/O ports 116 may enable data exchanges or interaction with other devices, networks, or users. The I/O ports 116 may include serial ports (e.g., universal serial bus (USB) ports), parallel ports, audio ports, infrared (IR) ports, camera or other sensor ports, or the like. The display 118 may include a display screen or a projection that may present one or more graphical images provided by the electronic device 102, such as a user interface associated with an operating system, program, or application. Additionally, or alternatively, the display 118 may be implemented as a display port or a virtual interface through which graphical content of the electronic device 102 is communicated or presented.

The electronic device 102 may include a wireless transceiver 120 and an antenna array including multiple antennas 126, which may be coupled one to another. The wireless transceiver 120 may provide connectivity to one or more networks and/or other wireless devices via the wireless link 106. Additionally, or alternatively, the electronic device 102 may include a wired transceiver (not shown in FIG. 1), such as an Ethernet or fiber optic transceiver for communicating over a wired local area network (LAN), an intranet, or the Internet. The wireless transceiver 120 may facilitate communication over any suitable type of wireless network, such as a WLAN, a WPAN, a peer-to-peer (P2P) network, a mesh network, a cellular network, a wireless wide area network (WWAN), and/or a navigational network (e.g., a Global Navigation Satellite System (GNSS)). The electronic device 102 may communicate various data and control information bidirectionally with a cellular network via the network node 104 using the wireless transceiver 120. Additionally, or alternatively, the electronic device 102 may communicate directly with peer devices, an alternative wireless network, or the like using the wireless transceiver 120.

The wireless transceiver 120 includes circuitry and logic for transmitting and receiving signals via two or more antennas 126. The wireless transceiver 120 can include various components, including amplifiers, mixers, switches, analog-to-digital converters (ADCs), digital-to-analog converters (DACs), filters, and/or other suitable components for conditioning transmitted and/or received signals. The wireless transceiver 120 may include logic to perform in-phase (I) operations and/or quadrature (Q) operations, collectively I/Q operations, such as synthesis, encoding, modulation, decoding, demodulation, or the like. In some cases, the wireless transceiver 120 may include a first set of components implemented as a transmitter and a separate second set of components implemented as a receiver. Additionally, or alternatively, the wireless transceiver 120 can be implemented using multiple or different sections to implement respective transmitting and receiving operations (e.g., separate transmit and receive chains) and/or one or more components that are shared by transmit and receive chains.

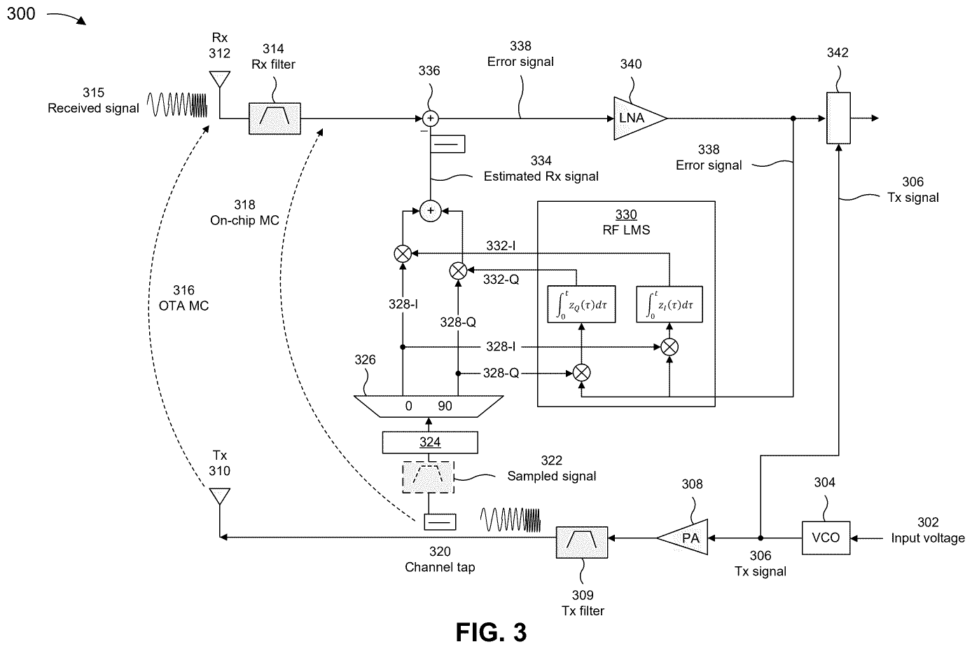

As shown in FIG. 1, the electronic device 102 includes a cancellation component 122 that may be connected to or at least partially included within the wireless transceiver 120 and/or a processor 124. As used herein, the term “connect” or “connected” refers to an electrical connection, including a direct connection (e.g., connecting discrete circuit elements via a same node) or an indirect connection (e.g., connecting discrete circuit elements via one or more other devices or other discrete circuit elements). The cancellation component 122 and the processor 124 can be respectively implemented within or separate from the wireless transceiver 120. The cancellation component 122 can be implemented in software or hardware. In some instances, the cancellation component 122 can be incorporated in or realized using software, firmware, hardware, fixed logic circuitry, or combinations thereof. The cancellation component 122 can be implemented within an IC or as part of the processor 124 or another electronic component of the electronic device 102. In some aspects, the processor 124 may execute computer-executable instructions that are stored within the computer-readable storage medium 110 to implement the cancellation component 122. In operation, the cancellation component 122 can cancel self-interference caused by simultaneous transmit and receive operations (e.g., interference due to mutual coupling) to enable detection of relatively weak reflections that are analyzed for proximity detection, distance measurement, velocity measurement, or the like. Accordingly, as described herein, the cancellation component 122 can at least partially implement proximity detection, distance measurement, velocity measurement, or the like using a combination of analog self-interference cancellation and digital feedback for adaptive mutual coupling delay compensation, as described in more detail with reference to FIGS. 3-6.

For example, in some aspects, the wireless transceiver 120 includes a transmitter configured to transmit a first FMCW signal and a receiver configured to receive a second FMCW signal associated with self-interference caused by a mutual coupling from the transmitter to the receiver. The cancellation component 122 may modulate a sample of the first FMCW signal based on a frequency offset associated with the mutual coupling from the transmitter to the receiver; generate an estimate of the second FMCW signal based on the modulated sample of the first FMCW signal; and cancel the self-interference caused by the mutual coupling from the transmitter to the receiver based on the estimate of the second FMCW signal.

Additionally, or alternatively, in some aspects, the cancellation component 122 may sample a transmit chirp; modulate the transmit chirp with a CW tone having a frequency based on a mutual coupling delay associated with the transmit chirp; estimate a receive chirp based on the modulated transmit chirp and one or more estimated parameters associated with a mutual coupling channel; and cancel a mutual coupling signal from the receive chirp based on the estimated receive chirp.

Additionally, or alternatively, in some aspects, the cancellation component 122 may obtain a beat signal that combines a target signal to be sensed with an interfering signal caused by mutual coupling from a transmitter to a receiver; apply a DFT to the beat signal to generate a spectrum representing the beat signal in a frequency domain; generate a CW tone having a frequency associated with a maximum peak in the spectrum representing the beat signal; and provide the CW tone to a cancellation filter configured to cancel a mutual coupling signal from a receive chirp based on a sampled transmit chirp, the CW tone, and one or more parameters associated with the mutual coupling.

The processor 124, which can be implemented as a modem or part of a modem, may control the wireless transceiver 120 and enable wireless communication or sensing (e.g., proximity detection, distance measurement, velocity measurement, or the like) to be performed. The processor 124 can include a portion of the computer-readable storage medium 110 and/or access the computer-readable storage medium 110 to obtain computer-readable instructions. The processor 124 can include baseband circuitry to perform high-rate sampling processes that can include analog-to-digital conversion, digital-to-analog conversion, Fourier transforms, gain correction, skew correction, frequency translation, or the like. The processor 124 can provide communication data to the wireless transceiver 120 for transmission and process a baseband version of a signal obtained from the wireless transceiver 120 to generate data, which can be provided to other parts of the electronic device 102 via a suitable interface for wireless communication or sensing.

In some cases, the wireless transceiver 120 may include a controller (not shown in FIG. 1) that may be used to control or otherwise implement the cancellation component 122. The controller can include at least one processor and computer-readable storage medium, which stores computer-executable instructions (such as the application processor 108, the computer-readable storage medium 110, and the instructions 112). The processor and the CRM can be localized at one component or one IC chip or distributed across multiple components or IC chips. Together, a processor and associated instructions can be realized in separate circuitry, fixed logic circuitry, hard-coded logic, or the like. In some cases, the controller can be implemented as part of the wireless transceiver 120, the processor 124, the application processor 108, a special-purpose processor configured to perform sensing techniques, a general-purpose processor, and/or any suitable combination thereof.

As indicated above, FIG. 1 is provided as an example. Other examples may differ from what is described with regard to FIG. 1.

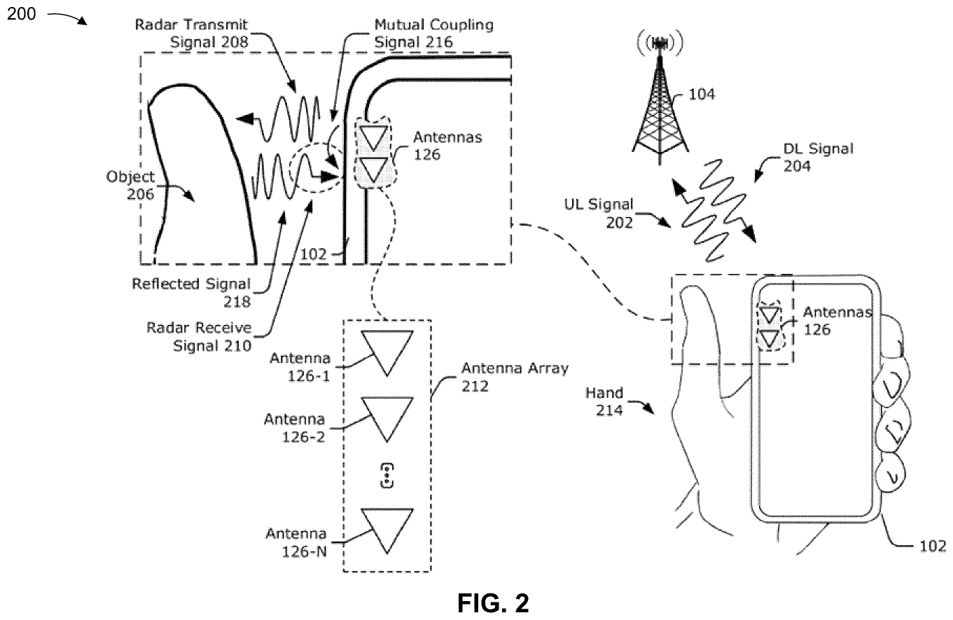

FIG. 2 is a diagram illustrating an example environment 200 in which self-interference cancellation may be performed for FMCW radar, in accordance with the present disclosure. In the example environment 200, an electronic device 102 may use FMCW radar techniques to sense information about one or more objects 206 in the environment 200, such as the presence of one or more objects 206, a distance to one or more objects 206, and/or a velocity of one or more objects 206 or the electronic device 102 based on a change in distance to one or more objects 206 over time, among other examples. For example, as shown in FIG. 2, the electronic device 102 is held in a hand 214 of a user, and the FMCW radar techniques may be used to sense information about an object 206 that corresponds to a thumb of the user in order to ensure compliance with MPE constraints on wireless transmissions by the electronic device 102. For example, the electronic device 102 may communicate with a network node 104 by transmitting an uplink signal 202 and/or receiving a downlink signal 204 via two or more antennas 126, and the thumb of the user can represent a proximate object 206 that may be exposed to radiation via the uplink signal 202. Accordingly, the electronic device 102 may use FMCW radar techniques to detect the thumb of the user and/or a distance to the thumb of the user to ensure that the uplink signal 202 satisfies any applicable MPE constraints that relate to limiting radiation exposure. The same or similar FMCW radar techniques may be used for various other suitable use cases, for example to detect or sense objects that are located further from the electronic device 102 than a portion of a hand 214 holding the electronic device 102. For example, FMCW radar techniques may be used to determine the velocity of a ball that is thrown or hit, or the FMCW radar techniques may be used to map a surrounding environment, such as to detect furniture in a room and/or the shape and size of the room.

In some aspects, to detect whether an object 206 is present in the environment 200 or within a detectable range of the electronic device 102, the electronic device 102 may transmit a radar transmit signal 208 via at least one of the antennas 126 and receive a radar receive signal 210 via at least another one of the antennas 126. In some cases, the radar receive signal 210 can be received during a portion of time during which the radar transmit signal 208 is transmitted. Furthermore, the radar transmit signal 208 and the radar receive signal 210 may be transmitted at the same carrier frequency. The radar transmit signal 208 and the radar receive signal 210 can be implemented as FMCW signals or a frequency-modulated pulsed signal. For example, the frequency modulation can include a linear frequency modulation (e.g., where the frequency of the signal increases or decreases linearly over time), a triangular frequency modulation (e.g., where the frequency of the signal increases linearly until a maximum frequency is reached, and then decreases linearly until a minimum frequency is reached), a sawtooth frequency modulation (e.g., where the frequency of the signal increases linearly until a maximum frequency is reached and then returns to a minimum frequency and linearly increases until the maximum frequency is reached), or the like.

Based on the radar receive signal 210, information about the object 206 can be sensed. For example, if an object 206 in the environment 200 is in a path of the radar transmit signal 208, the object 206 will totally or partially reflect the radar transmit signal 208 back to the electronic device 102, and the radar receive signal 210 may be delayed relative to the radar transmit signal 208, may have a different frequency than the radar transmit signal 208, and/or may have a different amplitude or phase than the radar transmit signal 208. Accordingly, the electronic device 102 may detect the presence of the object 206 and/or may determine an exact distance to the object 206 based on a frequency shift or frequency offset between the radar transmit signal 208 and the radar receive signal 210. Furthermore, a frequency difference between the radar transmit signal 208 and the radar receive signal 210 may indicate the range to the object 206, and a change in the distance to the object 206 over time may indicate the velocity of the object 206 and/or the electronic device 102 sensing the object 206.

As shown in FIG. 2, the radar receive signal 210 may include a reflected signal 218 (a reflection of the radar transmit signal 208) and a mutual coupling signal 216 associated with self-interference caused by the radar transmit signal 208. The reflected signal 218 includes a portion of the radar transmit signal 208 that is reflected by the object 206, and the mutual coupling signal 216 includes another portion of the radar transmit signal 208 that is not reflected by the object 206. For example, a propagation distance between the antennas 126 and the object 206, and a partial absorption of the radar transmit signal 208 via the object 206, causes the reflected signal 218 to be weaker (e.g., associated with a lower received power) relative to the mutual coupling signal 216. The reflected signal 218 may also have a different phase or frequency relative to the radar transmit signal 208 and the mutual coupling signal 216 based on reflection properties or motion of the object 206. In general, as described herein, the reflected signal 218 may contain information that can be used to detect the object 206 and/or measure a distance or range to the object 206.

As described herein, the mutual coupling signal 216 is present within the radar receive signal 210 due to a direct or indirect coupling between the one or more antennas 126 that are used to transmit the radar transmit signal 208 and the one or more antennas 126 that are used to receive the radar receive signal 210 (e.g., the antennas 126 are mutually coupled). For example, in the configuration depicted in FIG. 2, the antennas 126 are co-located or otherwise proximate to one another. Due to the proximity between the antennas 126, the antennas 126 are mutually coupled electromagnetically such that a portion of the energy that is radiated via the antenna(s) 126 used to transmit the radar transmit signal 208 generates self-interference (e.g., an over-the-air mutual coupling) that may cause challenges with detecting and/or measuring the reflected signal 218 due to the mutual coupling signal 216. In addition, the electronic device 102 may include a transmit chain to generate and condition the radar transmit signal 208 prior to transmission, and a receive chain to generate and condition the radar receive signal 210 after reception, which may result in an on-chip or on-device mutual coupling.

For example, the antennas 126 associated with the electronic device 102 may be arranged via one or more components and may have various configurations. For example, as shown in FIG. 2, the antennas 126 may comprise at least two different antennas, at least two antenna elements of an antenna array 212, at least two antenna elements associated with different antenna arrays, or any combination thereof. As shown in FIG. 2, the antenna array 212 may include multiple antennas 126-1 to 126-N, where N is a positive integer greater than one. Further, in some cases, the antenna array 212 may be arranged in multiple dimensions. Additionally, or alternatively, the antenna array 212 may be configured for beam management techniques, such as beam determination, beam measurement, beam reporting, or beam sweeping. A distance between the antennas 126 within the antenna array 212 can be based on frequencies that the wireless transceiver 120 emits. For example, the antennas 126 can be spaced apart by approximately half a wavelength from one another (e.g., by approximately half a centimeter (cm) apart for frequencies around 30 gigahertz (GHz)). The antennas 126 may be implemented as patch antennas, dipole antennas, bowtie antennas, and/or any suitable combination thereof.

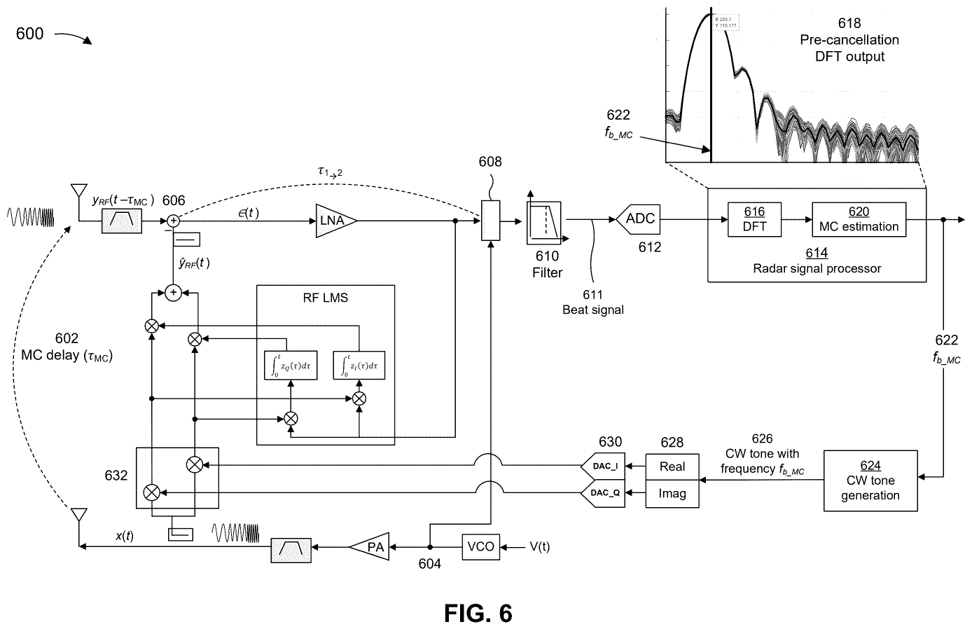

For example, the antennas 126 may include a first antenna 126-1 and a second antenna 126-2 of the antenna array 212. The first antenna 126-1 may transmit the radar transmit signal 208, and the second antenna 126-2 may receive the radar receive signal 210. The over-the-air and on-chip mutual coupling between the antennas 126 causes a portion of the radar transmit signal 208, which is represented by the mutual coupling signal 216, to be received by the second antenna 126-2 or otherwise leak into the radar receive signal 210. Because the mutual coupling signal 216 is significantly stronger than the reflected signal 218 (e.g., by approximately 25 decibels (dB) or more), the mutual coupling signal 216 can prevent the electronic device 102 from detecting the object 206. For example, the reflected signal 218 can be obscured by sidelobes of the mutual coupling signal 216. Accordingly, as described herein, the electronic device 102 may use the cancellation component 122 to estimate the mutual coupling signal 216 and cancel the mutual coupling signal 216 from the radar receive signal 210 such that the reflected signal 218 can be appropriately sensed, in order to detect the object 206 and/or measure distances, velocities, or other information based on the reflected signal 218 (e.g., based on a frequency shift between the radar transmit signal 208 and the reflected signal 218). For example, in some aspects, the cancellation component 122 may be configured to estimate the mutual coupling signal 216 in an analog domain (e.g., as described with reference to FIG. 3) and/or may be configured to estimate the mutual coupling signal 216 in the analog domain using feedback from a digital domain that adaptively compensates for a delay between the mutual coupling signal 216 and the estimate of the mutual coupling signal (e.g., as described with reference to FIG. 6).

As indicated above, FIG. 2 is provided as an example. Other examples may differ from what is described with regard to FIG. 2.

FIG. 3 is a diagram illustrating an example 300 associated with analog self-interference cancellation for FMCW radar, in accordance with the present disclosure. As shown in FIG. 3, a wireless device with FMCW sensing capabilities may include a transmitter with one or more components (e.g., a voltage-controlled oscillator (VCO) 304, a power amplifier (PA) 308, and a transmit antenna 310) that may generate, condition, and transmit a first FMCW signal, or Tx chirp, and a receiver with one or more components that may receive and condition a second FMCW signal, or Rx chirp. For example, the one or more components of the receiver may include a receive antenna 312 to receive the Rx chirp, an Rx filter 314 to filter out signals that fall outside a band of interest, and an LNA 340 that may amplify the Rx chirp. For example, as shown in FIG. 3, a time-varying input voltage 302, denoted v(t), may be provided to the VCO 304 to generate an FMCW transmit signal 306. For example, the input voltage May oscillate between a minimum voltage and a maximum voltage at a rate that changes (e.g., increases or decreases) over time according to a linear, triangular, sawtooth, or other pattern. As further shown in FIG. 3, the FMCW transmit signal 306 is then amplified by the PA 308, processed by a Tx bandpass filter 309 to filter out signals that fall outside a band of interest, and then transmitted via the transmit antenna 310. If an object in a surrounding environment is in a path of the FMCW transmit signal 306, the object will totally or partially reflect the FMCW transmit signal 306 back to the wireless device, and a reflection of the FMCW transmit signal 306 may be received at the receive antenna 312. Due to a propagation delay, the reflection of the FMCW transmit signal 306 may have a different frequency, amplitude, and/or phase than the FMCW transmit signal 306 when the reflection of the FMCW transmit signal 306 arrives at the receive antenna 312. Accordingly, a frequency difference between the FMCW transmit signal 306 and the reflection of the FMCW transmit signal 306 may indicate the presence of, or distance to, one or more objects in the environment around the wireless device.

However, due to an over-the-air mutual coupling 316 and/or an on-chip mutual coupling 318, a signal 315 that is received via the receive antenna 312, filtered by the Rx bandpass filter 314, and then provided as an input to the LNA 340 may comprise a mutual coupling signal (or mutual coupling component) and a target signal that corresponds to the reflected version of the FMCW transmit signal 306. For example, as described herein, mutual coupling generally results from the electromagnetic interaction between nearby antennas (e.g., transmit antenna 310 and receive antenna 312) and/or transducers (e.g., associated with the transmitter and receiver). Accordingly, the over-the-air mutual coupling 316 may occur when the FMCW transmit signal 306 is received at the receive antenna 312, and the on-chip mutual coupling 318 may occur when the FMCW transmit signal 306 leaks from the transmit path into the receive path through an antenna duplexer or other component. Within the FMCW signal 315 received at the receive antenna 312, the mutual coupling signal typically has a significantly higher power level than the target signal to be sensed (e.g., because the target signal typically travels a longer path than the mutual coupling signal, and an object that reflects the FMCW transmit signal 306 typically absorbs a portion of the energy). In some cases, the LNA 340 in the receive path may have a very high linearity, to avoid compression and/or saturation caused by TxSI or mutual coupling, such that the FMCW transmit signal 306 and a portion of the received FMCW signal 315 that is a reflected echo of the FMCW transmit signal 306 may be provided to a beating component 342 that may perform a beating operation in which the FMCW transmit signal 306 is multiplied with the reflected echo of the FMCW transmit signal 306 to generate a beat signal that can be provided to a radar signal processor (not shown, but which may be implemented in the application processor 108, processor 124 or modem, or another processor, or a combination thereof) for object detection, distance measurement, or the like. For example, the beating component 342 may multiply the two input signals (e.g., the FMCW transmit signal 306 and the reflected echo of the FMCW transmit signal 306) to generate a sinusoid with a frequency that is proportional to a round trip delay for the reflected FMCW transmit signal 306. However, the linearity requirement to overcome the high power level associated with the TxSI or mutual coupling is very stringent, and challenging to satisfy in practice.

Accordingly, as shown in FIG. 3, the wireless device with FMCW sensing capabilities may include or may be coupled to a filter configured to cancel the TxSI or mutual coupling from the received FMCW signal 315, where effectively cancelling the TxSI or mutual coupling may reduce an effect associated with phase noise reciprocal mixing that can significantly contribute to desensing the target signal contained within the received FMCW signal 315. For example, as shown in FIG. 3, the filter may include an RF LMS component 330 that implements a one-tap complex LMS algorithm, which may be used to cancel TxSI or the mutual coupling signal from the received FMCW signal 315 in an analog domain. For example, the filter may model the over-the-air mutual coupling 316 and the on-chip mutual coupling 318 together as a time-varying one-path complex channel (e.g., because the over-the-air mutual coupling 316 and the on-chip mutual coupling 318 making up the mutual coupling signal are typically associated with a very small delay spread that cannot be resolved by a radar bandwidth). For example, as described herein, the received FMCW signal 315 is identical to the FMCW transmit signal 306, except that the received FMCW signal 315 may have a different amplitude and/or phase than the FMCW transmit signal 306 that is at least partially caused by the mutual coupling. For example, the FMCW transmit signal 306 may be represented as a first time-varying signal,

$$x ( t ) = R e [ {e}^{\frac{j 2 π K}{2} {t}^{2}} {e}^{j {ω}_{c} t} ] ,$$

and the received FMCW signal 315 may be represented as a second time-varying signal,

$${y}_{R F} ( t ) = a R e [ {e}^{\frac{j 2 π K}{2} {t}^{2}} {e}^{j {ω}_{c} t} {e}^{j ϕ} ] ,$$

where a is an amplitude of the mutual coupling channel and jφ is a phase of the mutual coupling channel (e.g., where the sum of the over-the-air mutual coupling 316 and the on-chip mutual coupling is a(t)e^{jφ(t)}).

Accordingly, as described herein, the filter (which may be an example of the cancellation component 122) may implement the adaptive complex RF LMS algorithm to estimate and track the amplitude and the phase associated with the mutual coupling channel, such that the mutual coupling signal can be estimated according to a sample of the FMCW transmit signal 306. In this way, the estimated mutual coupling signal may be cancelled from the received FMCW signal 315, which may enable the target (reflected) signal to be appropriately sensed from the beat signal. For example, as shown in FIG. 3, the FMCW transmit signal 306 may be sampled at a channel tap 320 after amplification by the PA 308, and the sampled signal 322 may be provided to a component 324 that may apply a delay to the sampled signal 322 according to an estimate of a propagation delay associated with the over-the-air mutual coupling 316 (e.g., based on a time at which the FMCW transmit signal 306 is expected to arrive at the receive antenna 312). The sampled signal 322 is then provided to a splitter 326, which may split the sampled signal 322 into an in-phase (I) component 328-I and a quadrature (Q) component 328-Q to construct an equivalent complex plane that can be used to estimate the phase of the mutual coupling channel. For example, as shown in FIG. 3, the I component 328-I may be multiplied by a first weight 332-I, w_{I}(t), and the Q component 328-Q may be multiplied by a second weight 332-Q, w_{Q}(t), and the weighted I/Q components may then be combined to generate an estimated FMCW receive signal 334 in a real domain, ŷ_{RF}(t). Accordingly, at a cancellation node 336, the estimated FMCW receive signal 334 may be subtracted from the received FMCW signal 315 to cancel the mutual coupling signal from the received FMCW signal 315.

Furthermore, to generate the first weight 332-I and the second weight 332-Q, which are used to estimate the amplitude and the phase of the mutual coupling channel, an error signal 338 post-cancellation may be provided to the RF LMS component 330. For example, the error signal 338 may be denoted ε(t), where ε(t)=y_{RF}(t)−ŷ_{RF}(t). As shown in FIG. 3, the error signal 338 may be amplified by the LNA 340 and then provided to the RF LMS component 330, which may calculate a correlation of the error signal 338 with respect to the I component 328-I and the Q component 328-Q of the sampled signal 322. For example, as shown in FIG. 3, the correlation of the error signal 338 with respect to the I component 328-I may be determined by multiplying the error signal 338 with respect to the I component 328-I and then performing an integration to generate the first weight 332-I. Similarly, the correlation of the error signal 338 with respect to the Q component 328-Q may be determined by multiplying the error signal 338 with respect to the Q component 328-Q and then performing an integration to generate the second weight 332-Q. For example, the amplitude difference between the first weight 332-I and the second weight 332-Q may estimate the amplitude of the mutual coupling channel, and the phase difference between the first weight 332-I and the second weight 332-Q may estimate the phase of the mutual coupling channel.

As indicated above, FIG. 3 is provided as an example. Other examples may differ from what is described with regard to FIG. 3 and/or include additional elements. In some examples, data communication functionality is implemented and coupled to the antenna 310 and/or 312, or to other antennas not illustrated in FIG. 3. The data communication functionality may be coupled to the PA 308 and/or the LNA 340, or may use separate transmit and/or receive components (not illustrated). For example, the processor 124 may be configured to communicate data with another device using the wireless transceiver 120, which may include the elements illustrated in FIG. 3 and/or other electronic components.

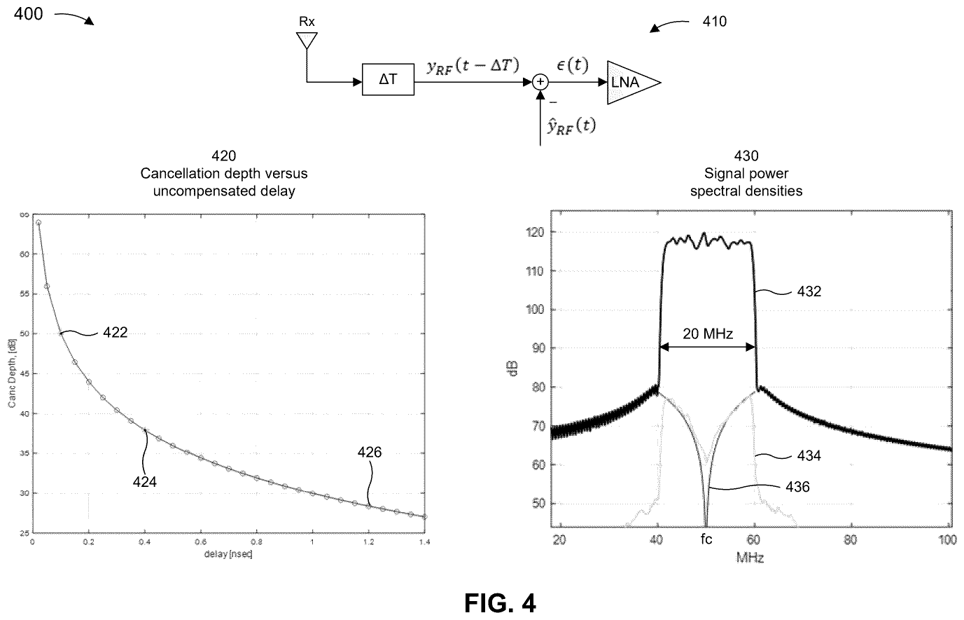

FIG. 4 is a diagram illustrating an example 400 associated with an uncompensated delay between a received FMCW signal and an estimated mutual coupling signal, in accordance with the present disclosure. For example, even in cases where a mutual coupling channel from a transmitter to a receiver is perfectly estimated (e.g., weights representing the amplitude and the phase associated with the mutual coupling channel are perfectly estimated), there is also an uncompensated relative delay between the received mutual coupling signal and the estimated mutual coupling signal at a cancellation node (e.g., a point in the receive path where the estimated mutual coupling signal is cancelled from the received mutual coupling signal, for example at node 336). For example, as shown by reference number 410, an FMCW signal may be received at a receive antenna (e.g., 312) at a first time, t−ΔT, and the FMCW signal may be estimated at a second time, t, that is delayed relative to the first time, such that ΔT represents a delay between the time when the FMCW signal arrives at the receive antenna and a time when the estimated mutual coupling signal is cancelled from the received FMCW signal. As a result, the uncompensated relative delay between the received signal, y_{RF}(t−ΔT), and the estimated mutual coupling signal, ŷ_{RF}(t), may degrade a cancellation depth (e.g., the TxSI or mutual coupling power cancelled from the received FMCW signal significantly decreases as the uncompensated delay increases, even at a sub-nanosecond scale). For example, referring to FIG. 4, plot 420 depicts the cancellation depth versus the uncompensated delay, where the cancellation depth is higher when the uncompensated delay is low and degraded as the uncompensated delay increases.

For example, point 422 indicates a cancellation depth of about 50 dB for an uncompensated delay of 0.1 nanoseconds, point 424 indicates a cancellation depth of about 38 dB for an uncompensated delay of 0.4 nanoseconds, and point 426 indicates a cancellation depth of about 28 dB for an uncompensated delay of 1.2 nanoseconds. Furthermore, as shown by plot 430, the cancellation depth may be reduced at higher frequencies and lower frequencies within the radar bandwidth (e.g., frequencies that are farther from a center frequency) due to a larger uncompensated relative delay. For example, referring to plot 430, curve 432 depicts the power associated with the received FMCW signal (y_{RF}) for a 20 megahertz (MHz) bandwidth with a center frequency fc, curve 434 depicts the residual signal spectrum post-cancellation, and curve 436 depicts the simulated residual signal spectrum post-cancellation. As shown, the residual signal spectrum has a characteristic V-shape with respect to frequency, where cancellation is reduced for the higher frequency components and the lower frequency components within the radar bandwidth due to the uncompensated relative delay (e.g., the residual signal spectrum post-cancellation would be relatively flat without the uncompensated relative delay).

As indicated above, FIG. 4 is provided as an example. Other examples may differ from what is described with regard to FIG. 4.

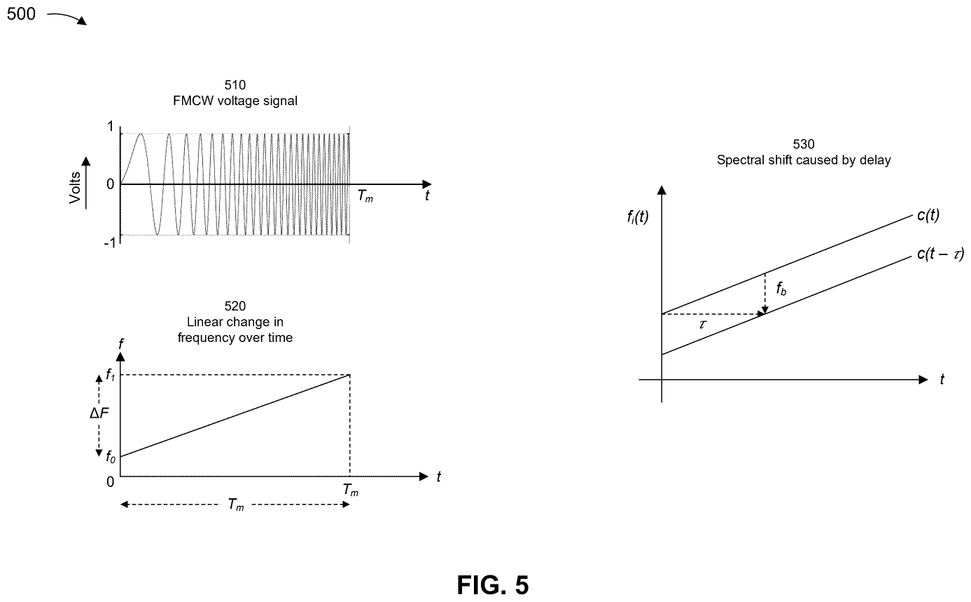

FIG. 5 is a diagram illustrating an example 500 associated with a spectral shift caused by a delay between example FMCW signals, in accordance with the present disclosure. For example, a delay applied to an FMCW signal (for example, a chirp) results in a spectral shift in a frequency domain that is proportional to the delay, and some aspects described herein may exploit this property of FMCW signals in order to estimate the uncompensated delay between a received FMCW signal and a mutual coupling signal to be cancelled from the received FMCW signal. For example, plot 510 illustrates a time-varying voltage signal that may be used to generate an FMCW signal with a frequency that increases linearly over time. In particular, as shown by plot 510, the time-varying voltage has a sinusoidal shape, which oscillates between a minimum voltage and a maximum voltage at a rate that increases linearly over a time period, Tₘ. Accordingly, as shown by plot 520, the resulting FMCW signal has a first frequency f₀ at time to and a second frequency f₁ at time Tₘ, such that

$$K = \frac{Δ F}{{T}_{m}} ,$$

where K is the slope of the frequency of the FMCW signal and ΔF=f₁−f₀. Accordingly, referring to plot 530, the frequency of a first FMCW signal (e.g., a transmitted signal) over time may be denoted c(t), and the frequency of a second FMCW signal that has a delay of t relative to the first FMCW signal (e.g., a reflection of the transmitted signal or a mutual coupling signal associated with the transmitted signal) may be denoted c(t−τ). As shown, a frequency offset between the first FMCW signal and the second FMCW signal at time t may be denoted f_{b}. Accordingly, in order to delay a first chirp to compensate for a delay between the first chirp and a second chirp, the first chirp may be modulated by a CW tone with a frequency f_{b}=Kτ, where Kτ is the slope of the frequency at time τ. In other words, to delay an estimated mutual coupling signal, ŷ_{RF}(t), according to a delay relative to a received FMCW signal, y_{RF}(t−ΔT) (e.g., the delay t is a mutual coupling delay), the transmitted signal that is sampled and used to estimate the mutual coupling signal may be modulated by a CW tone with a frequency f_{b_MC}.

As indicated above, FIG. 5 is provided as an example. Other examples may differ from what is described with regard to FIG. 5.

FIG. 6 is a diagram illustrating an example 600 associated with analog self-interference cancellation for FMCW radar with digital feedback for adaptive delay compensation, in accordance with the present disclosure.

As shown in FIG. 6, a wireless device with FMCW sensing capabilities may include a transmitter with one or more components (e.g., a VCO 304, a PA, and a transmit antenna) that may generate, condition, and transmit a first FMCW signal, or Tx chirp, and a receiver with one or more components (e.g., a receive antenna and an LNA) that may receive and condition a second FMCW signal, or Rx chirp. For example, as shown in FIG. 6, a time-varying input voltage, denoted v(t), may be provided to the VCO to generate an FMCW transmit signal. For example, the input voltage may oscillate between a minimum voltage and a maximum voltage at a rate that changes (e.g., increases or decreases) over time according to a linear, triangular, sawtooth, or other pattern. As further shown in FIG. 6, the FMCW transmit signal is then amplified by the PA and transmitted via the transmit antenna. If an object in a surrounding environment is in a path of the FMCW transmit signal, the object will totally or partially reflect the FMCW transmit signal back to the wireless device, and a reflection of the FMCW transmit signal may be received at the receive antenna. Due to a propagation delay, the reflection of the FMCW transmit signal may have a different frequency, amplitude, and/or phase than the FMCW transmit signal when the reflection of the FMCW transmit signal arrives at the receive antenna. Accordingly, a frequency difference between the FMCW transmit signal chirp and the reflection of the FMCW transmit signal may indicate the presence or distance to one or more objects.

In addition, as described herein, an over-the-air mutual coupling and an on-chip mutual coupling may result in the FMCW receive signal at the input to the LNA combining a mutual coupling signal (or mutual coupling component) with a target signal that corresponds to the reflected version of the FMCW transmit signal. Accordingly, in some aspects, a filter (which may be an example of the cancellation component 122) may implement an adaptive complex RF LMS algorithm to estimate and track the amplitude and the phase associated with the mutual coupling channel, such that the mutual coupling signal can be estimated according to a sample of the FMCW transmit signal, and digital feedback may be used to compensate for a mutual coupling delay 602 from a first node 604 where the FMCW transmit signal is generated to a second node 606 where the mutual coupling signal is cancelled from the FMCW receive signal. For example, after a beating operation is performed at a third node 608 (e.g., at a beating component configured to perform a beating operation), the output from the third node 608 may be processed by a low pass filter 610 to remove a spectral component at twice the frequency and thereby retain the beat frequency. The low pass filter 610 outputs a beat signal 611, denoted s_{b}(t), which may be provided to an ADC 612. As described herein, the beat signal 611 may correspond to the sum of the mutual coupling signal and the target (reflected) signal, where the mutual coupling signal is associated with a first delay τ_{MC} and the target signal is associated with a second delay τ_{TRGT}, where τ_{TRGT}>>τ_{MC} (e.g., the delay associated with the transmitted FMCW signal propagating into the environment, reflecting off one or more objects, and arriving at the receive antenna is much larger than the mutual coupling delay associated with the transmitted FMCW signal leaking into the receive path via over-the-air and/or on-chip coupling).

Accordingly, in some aspects, the beat signal 611 may be provided to a radar signal processor 614 (e.g., the processor 108, 124, and/or another processor) after conversion to the digital domain, where the radar signal processor 614 may observe the beat signal 611 at a baseband frequency by analyzing the spectrum associated with the beat signal 611. For example, the radar signal processor 614 may include a DFT component 616, which may perform a DFT operation on the beat signal 611 to generate a spectrum that represents the beat signal 611 in a frequency domain. For example, in FIG. 6, reference number 618 corresponds to an example output from the DFT component 616 prior to digital cancellation of the mutual coupling delay. In some aspects, the beat frequency associated with the mutual coupling signal is proportional to the coupling delay, where the beat frequency associated with the mutual coupling signal, denoted f_{b_MC}, represents the total delay from node 604 to node 608. In other words, the coupling delay associated with the beat signal 611 includes the mutual coupling delay τ_{MC} and an additional delay from node 606 to node 608, denoted τ_{1→2}. In some aspects, the additional delay from node 606 to node 608, τ_{1→2}, may generally be very small (e.g., relative to the mutual coupling delay τ_{MC}), whereby f_{b_MC}~kτ_{MC} may be a relatively accurate estimate of the delay from node 604 to node 606, where the mutual coupling cancellation occurs. For example, f_{b_MC} may estimate a frequency shift that is caused by the mutual coupling delay from node 604 to node 606, and kτ_{MC} may represent a frequency of the mutual coupling signal at time τ_{MC} (e.g., a time when the received FMCW signal arrives at the cancellation node 606).

In some aspects, as described herein, the mutual coupling signal typically has a much higher power level than the target signal within a received FMCW signal. Accordingly, the frequency offset caused by the mutual coupling delay can be accurately estimated by a mutual coupling estimation component 620. For example, the mutual coupling estimation component 620 may identify a maximum peak in the post-DFT spectrum, shown by line 622 in FIG. 6, which may correspond to the frequency shift or frequency offset caused by the mutual coupling delay (e.g., because the mutual coupling power is very high compared to the power of the target signal). Accordingly, the mutual coupling estimation component 620 may identify the frequency associated with the peak in the post-DFT spectrum, which may be provided to a CW tone generation component 624 (e.g., using a numerically controlled oscillator (NCO) or lookup table (LUT)). Output of the radar signal processor 614 (which may be from the mutual coupling estimation component 620 or may bypass the mutual coupling estimation component) may also be used in other radar functions or by other radar processing/processors, such as to determine a distance to an object.

The CW tone generation component 624 may generate a CW tone 626 associated with the frequency offset caused by the mutual coupling delay. For example, as described herein, the CW 626 has a frequency f_{b_MC} that is an estimate of the frequency shift caused by the mutual coupling delay from node 604 to node 606 (e.g., corresponding to the maximum peak in the post-DFT output (e.g., the frequency offset caused by the mutual coupling delay). In some aspects, the CW tone 626 may include real and imaginary components 628 that are each input to a respective DAC to generate analog signals representing the real and imaginary components 628 of the CW tone 626. As shown, the analog representations of the real and imaginary components 628 of the CW tone 626 may then be provided to an adaptive cancellation component 632, which may include a first mixer to modulate a real component of the sampled FMCW signal to be transmitted with the analog representation of the real component 628 of the CW tone 626 and a second mixer to modulate an imaginary component of the sampled FMCW signal to be transmitted with the analog representation of the imaginary component 628 of the CW tone 626. In this way, the modulated FMCW signal may then be used to estimate the mutual coupling signal using the RF LMS algorithm in a similar manner as described above with reference to FIG. 3. In this way, the digital feedback that compensates for the mutual coupling delay may address issues related to aligning a timing of waveforms at the cancellation node 606, avoid lengthy and costly calibration processes, and adapt to changes in the mutual coupling delay.

As indicated above, FIG. 6 is provided as an example. Other examples may differ from what is described with regard to FIG. 6. For example, while the discussion above focuses on cancelling self-interference, the concepts described herein can also be used to cancel interference from other devices. For example, it may be beneficial to cancel radar signals sent from another device that may be interfering with reception of a reflected signal from the electronic device 102. In such examples, other peaks can be identified (by the radar signal processor 614) and tones generated for those peaks. The adaptive cancellation component (e.g., mixer 632) may then be used to cancel interfering signals from such other devices. The tone(s) generated may be unique to each interferer (e.g., self, from another device, etc.) to cancel one interferer at a time or multiple tones may be combined and provided to the adaptive cancellation component to cancel multiple interferers.

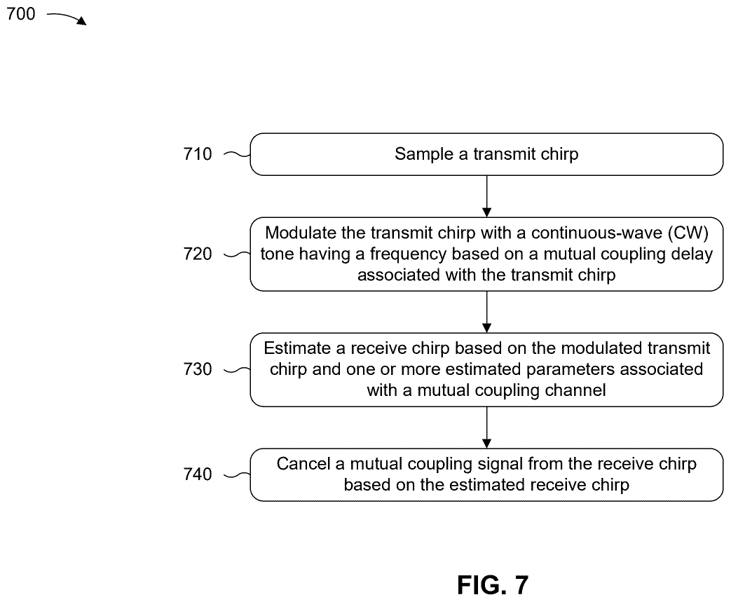

FIG. 7 is a diagram illustrating an example method 700 performed, for example, at a circuit or an apparatus of a circuit, in accordance with the present disclosure. Example process 700 is an example where the apparatus or the circuit (e.g., the adaptive cancellation component described in connection with FIG. 3 and/or the adaptive cancellation component described in connection with FIG. 6) performs operations associated with self-interference cancellation for FMCW radar.

As shown in FIG. 7, in some aspects, process 700 may include sampling a transmit chirp (block 710). For example, the circuit (e.g., at the channel tap 320 depicted in FIG. 3, or the similar channel tap depicted in FIG. 6) may sample a transmit chirp, as described above.

As further shown in FIG. 7, in some aspects, process 700 may include modulating the transmit chirp with a CW tone having a frequency based on a mutual coupling delay associated with the transmit chirp (block 720). For example, the circuit (e.g., using mixer 632, depicted in FIG. 6) may modulate the transmit chirp with a CW tone having a frequency based on a mutual coupling delay associated with the transmit chirp, as described above.

As further shown in FIG. 7, in some aspects, process 700 may include estimating a receive chirp based on the modulated transmit chirp and one or more estimated parameters associated with a mutual coupling channel (block 730). For example, the circuit (e.g., using the RF LMS component 330 depicted in FIG. 3, or the similar RF LMS component depicted in FIG. 5) may estimate a receive chirp based on the modulated transmit chirp and one or more estimated parameters associated with a mutual coupling channel, as described above.

As further shown in FIG. 7, in some aspects, process 700 may include canceling a mutual coupling signal from the receive chirp based on the estimated receive chirp (block 740). For example, the circuit (e.g., at the cancellation node 336 depicted in FIG. 3, or the similar cancellation node depicted in FIG. 5) may cancel a mutual coupling signal from the receive chirp based on the estimated receive chirp, as described above.

Process 700 may include additional aspects, such as any single aspect or any combination of aspects described below and/or in connection with one or more other processes described elsewhere herein.

In a first aspect, the frequency of the CW tone is based on a frequency offset between the transmit chirp and the receive chirp that is caused by the mutual coupling delay.

In a second aspect, alone or in combination with the first aspect, process 700 includes obtaining a beat signal by multiplying the transmit chirp with an interfering signal caused by mutual coupling from a transmitter to a receiver, and applying a DFT to the beat signal to generate a spectrum representing the beat signal in a frequency domain, wherein the frequency of the CW tone is associated with a maximum peak in the spectrum representing the beat signal in the frequency domain.

In a third aspect, alone or in combination with one or more of the first and second aspects, process 700 includes generating the CW tone in a digital domain based on the mutual coupling delay associated with the transmit chirp, and converting the CW tone from the digital domain to an analog domain to generate an analog representation of the CW tone, wherein the sample of the transmit chirp is modulated using the analog representation of the CW tone.

In a fourth aspect, alone or in combination with one or more of the first through third aspects, the CW tone is generated in the digital domain using an NCO or an LUT.

In a fifth aspect, alone or in combination with one or more of the first through fourth aspects, the receive chirp is estimated from the modulated transmit chirp according to an analog LMS algorithm.

In a sixth aspect, alone or in combination with one or more of the first through fifth aspects, estimating the receive chirp comprises generating an in-phase component and a quadrature component equivalent to the modulated transmit chirp in a complex plane, projecting an error signal associated with a mutual coupling cancellation onto the in-phase component and the quadrature component to generate one or more weights associated with the mutual coupling channel, and estimating the receive chirp based on the in-phase component and the quadrature component equivalent to the modulated transmit chirp and based on the one or more weights associated with the mutual coupling channel.

In a seventh aspect, alone or in combination with one or more of the first through sixth aspects, the one or more estimated parameters associated with a mutual coupling channel include an amplitude and a phase associated with the mutual coupling channel.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

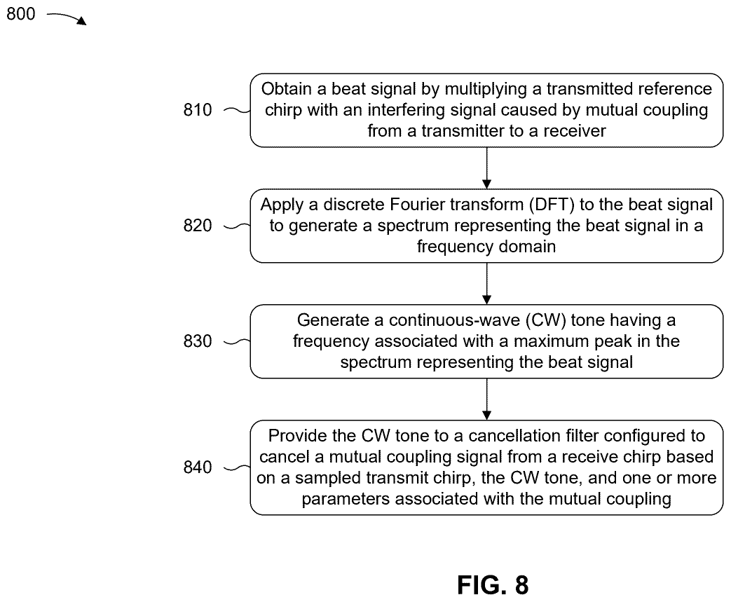

FIG. 8 is a diagram illustrating an example process 800 performed, for example, at a circuit or an apparatus of a circuit, in accordance with the present disclosure. Example process 800 is an example where the apparatus or the circuit (e.g., the adaptive cancellation component described in connection with FIG. 3 and/or the adaptive cancellation component described in connection with FIG. 6) performs operations associated with self-interference cancellation for FMCW radar.

As shown in FIG. 8, in some aspects, process 800 may include obtaining, by the circuit, a beat signal by multiplying a transmitted reference chirp with an interfering signal caused by mutual coupling from a transmitter to a receiver (block 810). For example, the circuit may obtain (e.g., from the beating component 342 depicted in FIG. 3, or the similar beating component depicted in FIG. 5) a beat signal that combines a target signal to be sensed with an interfering signal caused by mutual coupling from a transmitter to a receiver, as described above.

As further shown in FIG. 8, in some aspects, process 800 may include applying a DFT to the beat signal to generate a spectrum representing the beat signal in a frequency domain (block 820). For example, the circuit (e.g., using the radar signal processor 614 and/or DFT component 616 depicted in FIG. 6) may apply a DFT to the beat signal to generate a spectrum representing the beat signal in a frequency domain, as described above.

As further shown in FIG. 8, in some aspects, process 800 may include generating a CW tone having a frequency associated with a maximum peak in the spectrum representing the beat signal (block 830). For example, the circuit (e.g., using the CW tone generation component 624, the DACs 628, and/or the mixer depicted in FIG. 6) may generate a CW tone having a frequency associated with a maximum peak in the spectrum representing the beat signal, as described above.

As further shown in FIG. 8, in some aspects, process 800 may include providing the CW tone to a cancellation filter configured to cancel a mutual coupling signal from a receive chirp based on a sampled transmit chirp, the CW tone, and one or more parameters associated with the mutual coupling (block 840). For example, the circuit may provide the CW tone to a cancellation filter (e.g., via mixer 632 depicted in FIG. 6) configured to cancel a mutual coupling signal from a receive chirp based on a sampled transmit chirp, the CW tone, and one or more parameters associated with the mutual coupling, as described above.

Process 800 may include additional aspects, such as any single aspect or any combination of aspects described below and/or in connection with one or more other processes described elsewhere herein.

In a first aspect, generating the CW tone comprises generating the CW tone in a digital domain based on the frequency associated with the maximum peak in the spectrum representing the beat signal, and converting the CW tone from the digital domain to an analog domain to generate an analog representation of the CW tone, wherein the analog representation of the CW tone is provided to the cancellation filter.

In a second aspect, alone or in combination with the first aspect, the CW tone is generated in the digital domain using an NCO or an LUT.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

The following provides an overview of some Aspects of the present disclosure:

Aspect 1: A wireless device, comprising: a transmitter configured to transmit a first frequency-modulated continuous-wave (FMCW) signal; a receiver configured to receive a second FMCW signal associated with self-interference caused by a mutual coupling from the transmitter to the receiver; an adaptive cancellation component configured to: modulate a sample of the first FMCW signal based on a frequency offset associated with the mutual coupling from the transmitter to the receiver; generate an estimate of the second FMCW signal based on the modulated sample of the first FMCW signal; and cancel the self-interference caused by the mutual coupling from the transmitter to the receiver based on the estimate of the second FMCW signal.

Aspect 2: The wireless device of Aspect 1, wherein the frequency offset associated with the mutual coupling from the transmitter to the receiver is indicative of a relative delay between the first FMCW signal and the second FMCW signal.

Aspect 3: The wireless device of any of Aspects 1-2, wherein the sample of the first FMCW signal is modulated according to a continuous-wave (CW) tone that is based on the frequency offset associated with the mutual coupling from the transmitter to the receiver.

Aspect 4: The wireless device of any of Aspects 1-3, further comprising a radar signal processing component configured to: obtain a beat signal by multiplying a transmitted reference chirp corresponding to the first FMCW signal with an interfering signal caused by the mutual coupling from the transmitter to the receiver; and apply a discrete Fourier transform (DFT) to the beat signal to generate a spectrum representing the beat signal in a frequency domain, wherein the frequency offset associated with the mutual coupling from the transmitter to the receiver is a frequency value corresponding to a maximum peak in the spectrum representing the beat signal in the frequency domain.

Aspect 5: The wireless device of any of Aspects 1-4, wherein the adaptive cancellation component is further configured to: generate a continuous-wave (CW) tone in a digital domain based on the frequency offset associated with the mutual coupling from the transmitter to the receiver; and convert the CW tone from the digital domain to an analog domain to generate an analog representation of the CW tone, wherein the sample of the first FMCW signal is modulated using the analog representation of the CW tone.

Aspect 6: The wireless device of Aspect 5, wherein the CW tone is generated in the digital domain using a numerically-controlled oscillator or a lookup table.

Aspect 7: The wireless device of any of Aspects 1-6, wherein the adaptive cancellation component is configured to generate the estimate of the second FMCW signal according to a one-tap complex analog least mean squared (LMS) algorithm.

Aspect 8: The wireless device of Aspect 7, wherein the adaptive cancellation component is configured to: generate an in-phase component and a quadrature component equivalent to the modulated sample of the first FMCW signal in a complex plane; project an error signal associated with a cancellation of the self-interference onto the in-phase component and the quadrature component to estimate a phase and amplitude associated with the mutual coupling from the transmitter to the receiver; and generate the estimate of the second FMCW signal based on the in-phase component and the quadrature component equivalent to the modulated sample of the first FMCW signal in the complex plane and on the estimated phase and amplitude associated with the mutual coupling from the transmitter to the receiver.

Aspect 9: The wireless device of any of Aspects 1-8, wherein the self-interference caused by the mutual coupling from the transmitter to the receiver is cancelled at a node that is coupled to an input of a low-noise amplifier in the receiver.

Aspect 10: A method for mutual coupling cancellation, comprising: sampling, by a circuit, a transmit chirp; modulating, by the circuit, the transmit chirp with a continuous-wave (CW) tone having a frequency based on a mutual coupling delay associated with the transmit chirp; estimating, by the circuit, a receive chirp based on the modulated transmit chirp and one or more estimated parameters associated with a mutual coupling channel; and cancelling, by the circuit, a mutual coupling signal from the receive chirp based on the estimated receive chirp.

Aspect 11: The method of Aspect 10, wherein the frequency of the CW tone is based on a frequency offset between the transmit chirp and the receive chirp that is caused by the mutual coupling delay.

Aspect 12: The method of any of Aspects 10-11, further comprising: obtaining a beat signal by multiplying the transmit chirp with an interfering signal caused by mutual coupling from a transmitter to a receiver; and applying a discrete Fourier transform (DFT) to the beat signal to generate a spectrum representing the beat signal in a frequency domain, wherein the frequency of the CW tone is associated with a maximum peak in the spectrum representing the beat signal in the frequency domain.

Aspect 13: The method of any of Aspects 10-12, further comprising: generating the CW tone in a digital domain based on the mutual coupling delay associated with the transmit chirp; and converting the CW tone from the digital domain to an analog domain to generate an analog representation of the CW tone, wherein the sample of the transmit chirp is modulated using the analog representation of the CW tone.

Aspect 14: The method of Aspect 13, wherein the CW tone is generated in the digital domain using a numerically-controlled oscillator or a lookup table.

Aspect 15: The method of any of Aspects 10-14, wherein the receive chirp is estimated from the modulated transmit chirp according to an analog least mean squared (LMS) algorithm.

Aspect 16: The method of any of Aspects 10-15, wherein estimating the receive chirp comprises: generating an in-phase component and a quadrature component equivalent to the modulated transmit chirp in a complex plane; projecting an error signal associated with a mutual coupling cancellation onto the in-phase component and the quadrature component to generate one or more weights associated with the mutual coupling channel; and estimating the receive chirp based on the in-phase component and the quadrature component equivalent to the modulated transmit chirp and based on the one or more weights associated with the mutual coupling channel.

Aspect 17: The method of any of Aspects 10-16, wherein the one or more estimated parameters associated with a mutual coupling channel include an amplitude and a phase associated with the mutual coupling channel.

Aspect 18: A method for adaptive delay compensation, comprising: obtaining, by a circuit, a beat signal by multiplying a transmitted reference chirp with an interfering signal caused by mutual coupling from a transmitter to a receiver; applying, by the circuit, a discrete Fourier transform (DFT) to the beat signal to generate a spectrum representing the beat signal in a frequency domain; generating, by the circuit, a continuous-wave (CW) tone having a frequency associated with a maximum peak in the spectrum representing the beat signal; and providing, by the circuit, the CW tone to a cancellation filter configured to cancel a mutual coupling signal from a receive chirp based on a sampled transmit chirp, the CW tone, and one or more parameters associated with the mutual coupling.

Aspect 19: The method of Aspect 18, wherein generating the CW tone comprises: generating the CW tone in a digital domain based on the frequency associated with the maximum peak in the spectrum representing the beat signal; and converting the CW tone from the digital domain to an analog domain to generate an analog representation of the CW tone, wherein the analog representation of the CW tone is provided to the cancellation filter.

Aspect 20: The method of Aspect 19, wherein the CW tone is generated in the digital domain using a numerically-controlled oscillator or a lookup table.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

The foregoing outlines features of various aspects so that those skilled in the art may better understand the aspects of the present disclosure. Those skilled in the art should appreciate that the present disclosure may be readily used as a basis for designing or modifying other processes and/or structures for carrying out the same purposes and/or achieving the same advantages of the aspects described herein. Those skilled in the art should also realize that such equivalent constructions do not depart from the spirit and scope of the present disclosure, and that various changes, substitutions, and alterations may be made herein without departing from the spirit and scope of the present disclosure.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A wireless device, comprising:
a transmitter configured to transmit a first frequency-modulated continuous-wave (FMCW) signal;
a receiver configured to receive a second FMCW signal associated with self-interference caused by a mutual coupling from the transmitter to the receiver;
an adaptive cancellation component configured to:
modulate a sample of the first FMCW signal based on a frequency offset associated with the mutual coupling from the transmitter to the receiver;
generate an estimate of the second FMCW signal based on the modulated sample of the first FMCW signal; and
cancel the self-interference caused by the mutual coupling from the transmitter to the receiver based on the estimate of the second FMCW signal.

2. The wireless device of claim 1, wherein the frequency offset associated with the mutual coupling from the transmitter to the receiver is indicative of a relative delay between the first FMCW signal and the second FMCW signal.

3. The wireless device of claim 1, wherein the sample of the first FMCW signal is modulated according to a continuous-wave (CW) tone that is based on the frequency offset associated with the mutual coupling from the transmitter to the receiver.

4. The wireless device of claim 1, further comprising a radar signal processing component configured to:
obtain a beat signal by multiplying a transmitted reference chirp corresponding to the first FMCW signal with an interfering signal caused by the mutual coupling from the transmitter to the receiver; and
apply a discrete Fourier transform (DFT) to the beat signal to generate a spectrum representing the beat signal in a frequency domain, wherein the frequency offset associated with the mutual coupling from the transmitter to the receiver is a frequency value corresponding to a maximum peak in the spectrum representing the beat signal in the frequency domain.

5. The wireless device of claim 1, wherein the adaptive cancellation component is further configured to:
generate a continuous-wave (CW) tone in a digital domain based on the frequency offset associated with the mutual coupling from the transmitter to the receiver; and
convert the CW tone from the digital domain to an analog domain to generate an analog representation of the CW tone, wherein the sample of the first FMCW signal is modulated using the analog representation of the CW tone.

6. The wireless device of claim 5, wherein the CW tone is generated in the digital domain using a numerically-controlled oscillator or a lookup table.

7. The wireless device of claim 1, wherein the adaptive cancellation component is configured to generate the estimate of the second FMCW signal according to a one-tap complex analog least mean squared (LMS) algorithm.

8. The wireless device of claim 7, wherein the adaptive cancellation component is configured to:
generate an in-phase component and a quadrature component equivalent to the modulated sample of the first FMCW signal in a complex plane;
project an error signal associated with a cancellation of the self-interference onto the in-phase component and the quadrature component to estimate a phase and amplitude associated with the mutual coupling from the transmitter to the receiver; and
generate the estimate of the second FMCW signal based on the in-phase component and the quadrature component equivalent to the modulated sample of the first FMCW signal in the complex plane and on the estimated phase and amplitude associated with the mutual coupling from the transmitter to the receiver.

9. The wireless device of claim 1, wherein the self-interference caused by the mutual coupling from the transmitter to the receiver is cancelled at a node that is coupled to an input of a low-noise amplifier in the receiver.

10. A method for mutual coupling cancellation, comprising:
sampling, by a circuit, a transmit chirp;
modulating, by the circuit, the transmit chirp with a continuous-wave (CW) tone having a frequency based on a mutual coupling delay associated with the transmit chirp;
estimating, by the circuit, a receive chirp based on the modulated transmit chirp and one or more estimated parameters associated with a mutual coupling channel; and
cancelling, by the circuit, a mutual coupling signal from the receive chirp based on the estimated receive chirp.

11. The method of claim 10, wherein the frequency of the CW tone is based on a frequency offset between the transmit chirp and the receive chirp that is caused by the mutual coupling delay.

12. The method of claim 10, further comprising:
obtaining a beat signal by multiplying the transmit chirp with an interfering signal caused by mutual coupling from a transmitter to a receiver; and
applying a discrete Fourier transform (DFT) to the beat signal to generate a spectrum representing the beat signal in a frequency domain, wherein the frequency of the CW tone is associated with a maximum peak in the spectrum representing the beat signal in the frequency domain.

13. The method of claim 10, further comprising:
generating the CW tone in a digital domain based on the mutual coupling delay associated with the transmit chirp; and
converting the CW tone from the digital domain to an analog domain to generate an analog representation of the CW tone, wherein the sample of the transmit chirp is modulated using the analog representation of the CW tone.

14. The method of claim 13, wherein the CW tone is generated in the digital domain using a numerically-controlled oscillator or a lookup table.

15. The method of claim 10, wherein the receive chirp is estimated from the modulated transmit chirp according to an analog least mean squared (LMS) algorithm.

16. The method of claim 10, wherein estimating the receive chirp comprises:
generating an in-phase component and a quadrature component equivalent to the modulated transmit chirp in a complex plane;
projecting an error signal associated with a mutual coupling cancellation onto the in-phase component and the quadrature component to generate one or more weights associated with the mutual coupling channel; and
estimating the receive chirp based on the in-phase component and the quadrature component equivalent to the modulated transmit chirp and based on the one or more weights associated with the mutual coupling channel.

17. The method of claim 10, wherein the one or more estimated parameters associated with a mutual coupling channel include an amplitude and a phase associated with the mutual coupling channel.

18. A method for adaptive delay compensation, comprising:
obtaining, by a circuit, a beat signal by multiplying a transmitted reference chirp with an interfering signal caused by mutual coupling from a transmitter to a receiver;
applying, by the circuit, a discrete Fourier transform (DFT) to the beat signal to generate a spectrum representing the beat signal in a frequency domain;
generating, by the circuit, a continuous-wave (CW) tone having a frequency associated with a maximum peak in the spectrum representing the beat signal; and
providing, by the circuit, the CW tone to a cancellation filter configured to cancel a mutual coupling signal from a receive chirp based on a sampled transmit chirp, the CW tone, and one or more parameters associated with the mutual coupling.

19. The method of claim 18, wherein generating the CW tone comprises:
generating the CW tone in a digital domain based on the frequency associated with the maximum peak in the spectrum representing the beat signal; and
converting the CW tone from the digital domain to an analog domain to generate an analog representation of the CW tone, wherein the analog representation of the CW tone is provided to the cancellation filter.

20. The method of claim 19, wherein the CW tone is generated in the digital domain using a numerically-controlled oscillator or a lookup table.
